(19) United States
(12) Patent Application Publication
(10) Pub. No.: US 2012/0090689 A1
(43) Pub. Date: Apr. 19, 2012

(54) SYSTEM AND METHOD FOR OPERATING A DRAIN VALVE

(75) Inventor: Kenneth Andrew Hodges, Roanoke, VA (US)

(73) Assignee: GRAHAM-WHITE MANUFACTURING A DRAIN VALVE, Salem, VA (US)

(21) Appl. No.: 12/906,222

(22) Filed: Oct. 18, 2010

(51) Int. Cl. F16K 31/00

(52) U.S. Cl. 137/12; 137/485

(57) ABSTRACT

A drain valve includes a valve body that defines an inlet seat and a first outlet seat downstream of the inlet seat. A first member has a first position in sealing engagement with the first outlet seat and a second position separated from the first outlet seat. A second member has a first location in sealing engagement with the inlet seat. A sensor downstream of the inlet seat generates a signal reflective of a pressure downstream of the inlet seat. A method for operating a drain valve includes moving a first element in a valve body to allow fluid flow through the valve body, moving a second element in the valve body to allow fluid flow through the valve body, and sensing a pressure in the valve body.

### FIELD OF THE INVENTION

The present invention generally involves a system and method for operating a drain valve. In particular, embodiments of the present invention may be used to determine the position of the drain valve in a compressed air system.

### BACKGROUND OF THE INVENTION

Pressurized systems, such as those commonly used in the braking systems of diesel locomotives, produce various contaminants and condensation that adversely affect the efficiency and function of the system. A drain valve may therefore be connected to the system to expel the contaminants and condensates. In some cases, the drain valve may be designed for local and remote operation so that contaminants and condensation may be drained at specific intervals or as needed. In addition, the drain valve may be designed so that the drain valve may be isolated from the pressurized system to enable testing, maintenance, and/or repair to the pressurized system and/or drain valve.

U.S. Pat. Nos. 3,262,464 and 4,336,821, assigned to the same assignee as the present invention, describe a suitable drain valve for performing this and other functions in pressurized air systems used with locomotive brakes. However, the possibility and tendency exists for misalignment of the drain valve that may result in excessive wear and/or damage to the pressurized system and/or drain valve if not corrected. For example, the drain valve may be inadvertently aligned to continuously drain fluid from the pressurized system, resulting in excessive wear to the pressurized system and/or drain valve. Alternately, the drain valve may be inadvertently aligned to isolate the drain valve from the pressurized system, resulting in a buildup of contaminants and condensates in the pressurized system.

Therefore, an improved system and method for operating a drain valve that determines the position of the drain valve to identify improperly aligned drain valves would be useful.

### BRIEF DESCRIPTION OF THE INVENTION

Aspects and advantages of the invention are set forth below in the following description, or may be obvious from the description, or may be learned through practice of the invention.

One embodiment of the present invention is a drain valve that includes a valve body that defines an inlet seat and a first outlet seat downstream of the inlet seat. A first member has a first position in sealing engagement with the first outlet seat and a second position separated from the first outlet seat. A second member has a first location in sealing engagement with the inlet seat. A sensor downstream of the inlet seat generates a signal reflective of a pressure downstream of the inlet seat.

Another embodiment of the present invention is a drain valve that includes a valve body that defines an inlet seat and first and second outlet seats downstream of the inlet seat. A first member has a first position in sealing engagement with the first outlet seat and a second position separated from the first outlet seat. A second member has a first location in sealing engagement with the inlet seat and a second location in sealing engagement with the second outlet seat. An actuator is operatively connected downstream of the inlet seat and compares a pressure downstream of the inlet seat to a predetermined limit.

Embodiments of the present invention may also include a method for operating a drain valve that includes moving a first element in a valve body to allow fluid flow through the valve body, moving a second element in the valve body to allow fluid flow through the valve body, and sensing a pressure in the valve body.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified side cross-section view of a drain valve according to one embodiment of the present invention;

FIG. 2 is a simplified side cross-section view of the drain valve shown in FIG. 1 in the remote drain position;

FIG. 3 is a simplified side cross-section view of the drain valve shown in FIG. 1 in the manual drain position; and

FIG. 4 is a simplified side cross-section view of the drain valve shown in FIG. 1 in the isolated position.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide a drain valve and a method for operating a drain valve. Although exemplary embodiments of the present invention are described and illustrated in the context of a pressurized air system, one of ordinary skill in the art will readily appreciate that embodiments of the present invention may be used as a drain valve in any pressurized system that benefits from periodic draining, and the present invention is not limited to a particular pressurized system unless specifically recited in the claims.

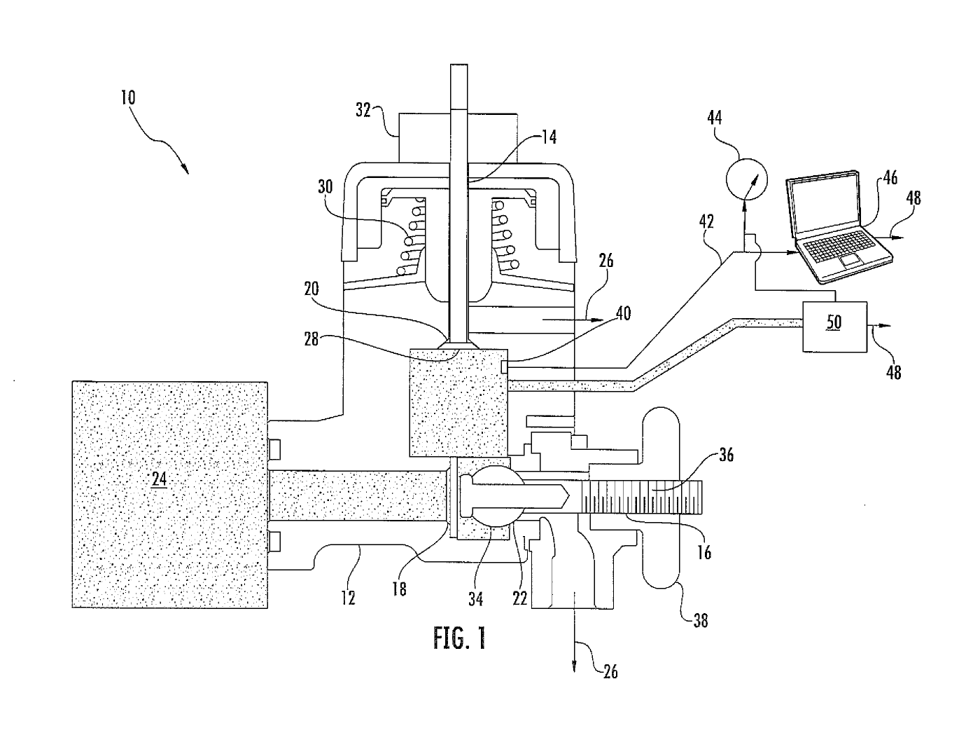

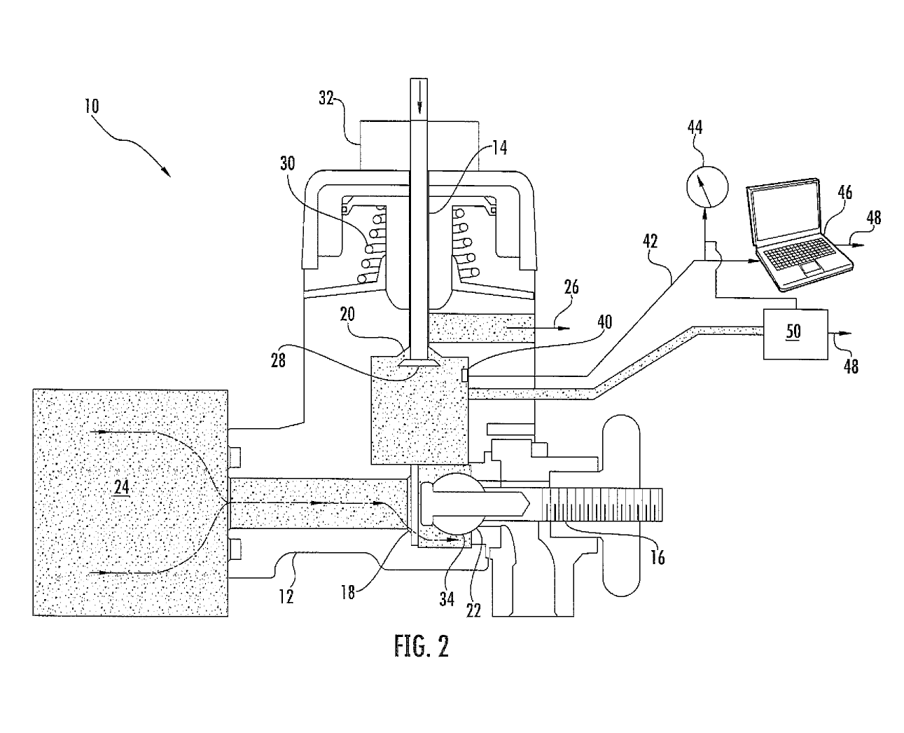

FIG. 1 provides a simplified side cross-section view of a drain valve 10 according to one embodiment of the present invention, and FIGS. 2-4 provide simplified cross-section views of the drain valve 10 shown in FIG. 1 in various alignments. As shown in each Figure, the drain valve 10 generally includes a valve body 12, a first member 14, and a second member 16. The valve body 12 defines an inlet seat 18 and first and second outlet seats 20, 22 downstream of the inlet seat 18. As used herein, “upstream” and “downstream” refer to the direction of fluid flow. For example, component A is upstream of component B and component B is downstream of component A if a fluid flows from component A to component B. When installed in a pressurized system 24, the valve body 12 is generally oriented so that the inlet seat 18 is proximate to the pressurized system 24, and the first and second outlet seats 20, 22 may be connected to a discharge path 26, such as a collection tank or the environment.

The first member 14 may comprise a first valve seat 28 having a first position and a second position. In the first position, the first valve seat 28 of the first member 14 is in sealing engagement with the first outlet seat 20, as shown in FIGS. 1, 3, and 4, to prevent fluid flow between the first valve seat 28 and the first outlet seat 20. The first position may be used, for example, during normal operations when fluid is not being drained through the drain valve 10. In the second position, the first valve seat 28 of the first member 14 is separated from the first outlet seat 20, as shown in FIG. 2, to allow fluid flow between the first valve seat 28 and the first outlet seat 20. The second position may be used, for example, during normal operations when remotely draining fluid from the pressurized system 24 through the drain valve 10. In this manner, the first member 14 prevents or permits fluid flow through the drain valve 10 in the first and second positions, respectively.

As shown in FIGS. 1-4, the drain valve 10 may further include a bias member 30 and/or means for moving the first member 14 between the first position and the second position. The bias member 30 may be operatively connected to the first member 14 to bias the first member 14 in at least one of the fust or second positions. For example, as shown in each Figure, the bias member 30 may urge the first member 14 against the first outlet seat 20 to provide sealing engagement between the first member 14 and the first outlet seat 20. The bias member 30 may comprise any suitable structure known to one of ordinary skill in the art for biasing components, such as, for example, a spring, a coil, a spring washer, or suitable equivalents. The means for moving the first member 14 between the first position and the second position may comprise any suitable structure known to one of ordinary skill in the art for moving one mechanical component with respect to another. For example, the means may comprise a threaded engagement between the first member 14 and the valve body 12. Alternately, or in addition, the means may comprise an electric, hydraulic, or pneumatic motor or piston operatively connected to the first member 14 to move the first member 14 with respect to the first outlet seat 20. As shown specifically in FIGS. 1-4, the means may also comprise a solenoid 32 operatively connected to the first member 14 so that energizing the solenoid 32 overcomes the force provided by the bias member 30, if present, to move the first member 14 away from the first outlet seat 20.

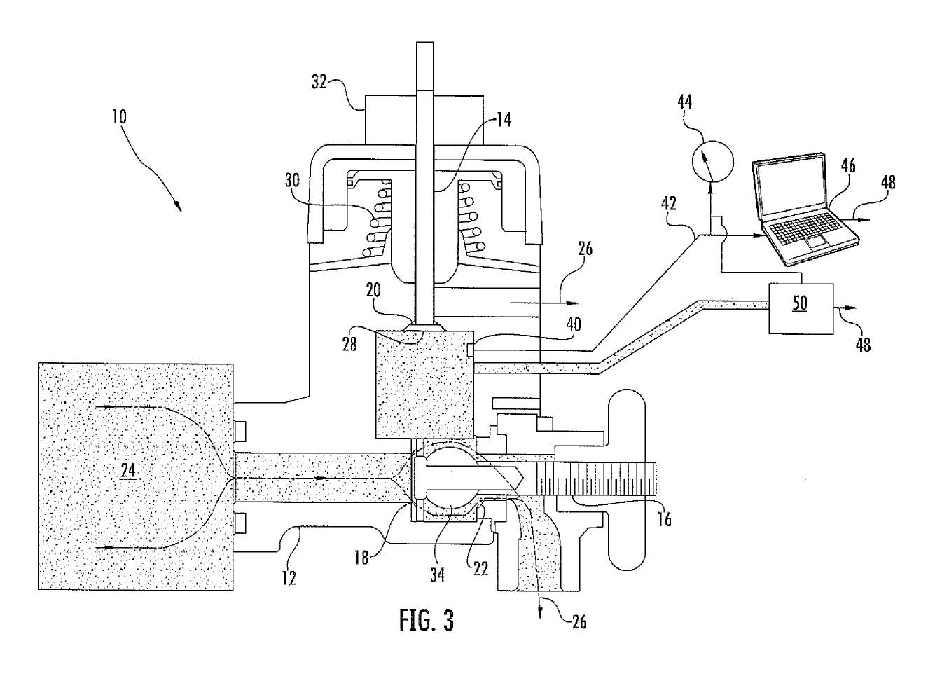

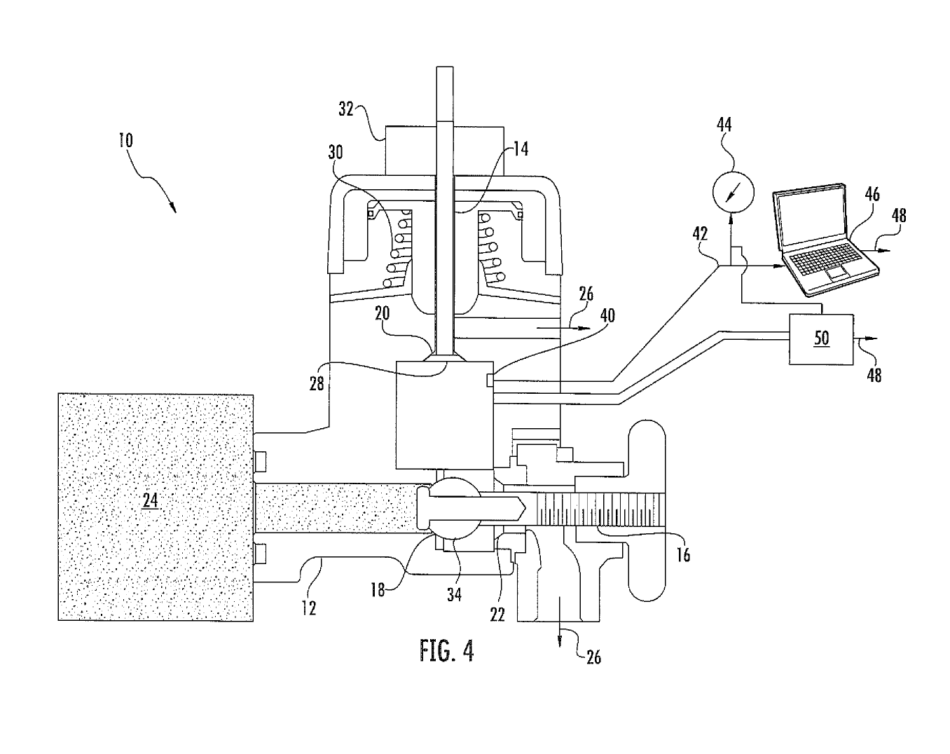

The second member 16 may comprise a second valve seat 34 having a first location and a second location. In the first location, the second valve seat 34 of the second member 16 is in sealing engagement with the inlet seat 18, as shown in FIG. 4, to prevent fluid flow between the second valve seat 34 and the inlet seat 18. The first location may be used, for example, to isolate components downstream of the inlet seat 18 from the pressurized system 24. In this manner, the second member 16 in the first location may allow for testing to be performed on the pressurized system 24 and/or maintenance and repair to be performed on components downstream of the inlet seat 18. In the second location, the second valve seat 34 of the second member 16 is in sealing engagement with the second outlet seat 22, as shown in FIGS. 1 and 2, to prevent fluid flow between the second valve seat 34 and the second outlet seat 22. The second location may be used, for example, during normal operations when fluid is not being manually drained through the drain valve 10. The second member 16 may further have a third or intermediate location in which the second valve seat 34 is separated from both the inlet seat 18 and the second outlet seat 22, as shown in FIG. 3, to allow fluid flow through the inlet seat 18, around the second valve seat 34, and through the second outlet seat 22. The third or intermediate location may be used, for example, to manually drain fluid from the pressurized system 24 during normal or shutdown operations. Means for moving the second member 16 between the first and second locations may comprise the same or equivalent structures previously described with respect to the means for moving the first number 14. For example, as shown in FIGS. 1-4, the means for moving the second member 16 between the first and second locations may comprise a threaded engagement 36 between the second member 16 and a hand wheel 38. Rotation of the hand wheel 38 may thus move the second member 16 between the first and second locations.

The various positions and locations of the first and second members 14, 16, and thus the operating modes of the drain valve 10, are shown in FIGS. 1-4. Specifically, FIG. 1 shows the drain valve 10 aligned for normal operations, with first member 14 in the first position, the second member 16 in the second position, and no fluid flow through the drain valve 10. FIG. 2 shows the drain valve 10 again aligned for normal operations, with the first member 14 moved to the second position to allow fluid flow past the first member 14 and through the drain valve 10. This alignment may exist, for example, during remote draining of the pressurized system 24. FIG. 3 shows the drain valve 10 aligned for manual draining of the pressurized system 24, with the first member 14 again in the first position and the second member 16 in the third or intermediate position to allow fluid flow past the second member 16 and through the drain valve 10. FIG. 4 shows the drain valve 10 isolated, with the second member 16 moved to the first position to prevent any fluid flow through the drain valve 10. Importantly, the alignment shown in FIG. 4 prevents any draining of the pressurized system 24, including remote draining as shown in FIG. 2, and it is this alignment that embodiments of the present invention detect, signal, and/or respond to.

As shown in FIGS. 1-4, the drain valve 10 includes one or more redundant systems for determining the alignment, and thus the operability, of the drain valve 10. For example, the drain valve 10 may include a sensor 40 operatively connected downstream of the inlet seat 18. The sensor 40 may comprise a pressure sensor that measures a pressure downstream of the inlet seat 18 and generates a signal 42 reflective of the pressure downstream of the inlet seat 18. The sensor 40 may transmit the signal 42 to an indicator 44, such as a pressure gauge or alarm system, to provide a visual or audible indication of the operability of the drain valve 10. Alternately, or in addition, the sensor 40 may transmit the signal 42 to a controller 46 that compares the signal 42 to a predetermined limit and generates a control signal 48 based on this comparison. The predetermined limit may be selected based on the minimum operating pressure for the pressurized system 24 or some other pressure value indicative of a misalignment of the drain valve 10. As used herein, the controller 46 may comprise a dedicated or shared microprocessor, hard-wired logic, programmed logic, or other application specific circuitry. The control signal 48 may then be used to control and/or adjust the operation of the pressurized system 24 based on the detected and indicated alignment of the drain valve 10. For example, in the event the comparison between the signal 42 and the predetermined limit indicates that the drain valve 10 is misaligned, as shown in FIG. 4 for example, the control signal 48 may implement corrective action to prevent damage in the pressurized system 24 due to the non-availability of the drain valve 10.

Alternately, or in addition, the drain valve 10 may include an actuator 50 to determine the alignment of the drain valve 10. The actuator 50 may be operatively connected downstream of the inlet seat 18 and may comprise a differential pressure detector, diaphragm, bellows, or similar structure to compare the pressure downstream of the inlet seat 18 to the predetermined limit. The actuator 50 may be operatively connected to the indicator 44 and/or controller 46 as previously described with respect to the sensor 40. Alternately, or in addition, the actuator 50 may generate the control signal 48 that may implement corrective action to prevent damage in the pressurized system 24 due to the non-availability of the drain valve 10.

The various operating modes of the drain valve 10 and one or more redundant systems for determining the alignment, and thus the operability, of the drain valve 10 will now be described as illustrated in FIGS. 1-4. In FIG. 1, the first valve member 14 is in sealing engagement with the first outlet seat 20, and the second valve member 16 is in sealing engagement with the second outlet seat 22. As a result, the drain valve 10 is aligned for normal operation, with no fluid flow through the drain valve 10. In this alignment, the signal 42 generated by the sensor 40 and/or actuator 50 to the indicator 44 and/or the controller 46 will reflect a pressure downstream of the inlet seat 18 that is approximately equal to the static pressure in the pressurized system 24, indicating that the drain valve 10 is properly aligned for normal and remote operation.

In FIG. 2, the second valve member 16 is again in sealing engagement with the second outlet seat 22; however, the first valve member 14 has been repositioned to the second position to allow fluid flow through the drain valve 10. As a result, the drain valve 10 is aligned for normal operation, and fluid is being drained from the pressurized system 24, past the first valve member 14 and first outlet seat 20, and out of the drain valve 10. In this alignment, the signal 42 generated by the sensor 40 and/or actuator 50 to the indicator 44 and/or the controller 46 will reflect a pressure downstream of the inlet seat 18 that, while less than the static pressure in the pressurized system 24, is sufficiently greater than atmospheric pressure to indicate that the drain valve 10 is in the process of draining fluid from the pressurized system 24. While fluid flow through the drain valve 10 is certainly a normal and anticipated event, uncontrolled or continuous fluid flow through the drain valve 10 may indicate a misalignment of the drain valve 10, a leaking drain valve 10, or other condition requiring attention to avoid an excessive loss of fluid from the pressurized system 24. The control signal 48, if present, may thus be used to implement corrective action, possibly after a specified time interval, to stop the fluid flow through the drain valve 10, provide a warning indication, or initiate other action to prevent damage in the pressurized system 24.

In FIG. 3, the first valve member 14 is again in sealing engagement with the first outlet seat 20, and the second valve member 16 has been repositioned to the third or intermediate location to manually drain fluid from the pressurized system 24 through the drain valve 10. As a result, fluid flows from the pressurized system 24, past the inlet seat 18, around the second valve member 16, past the second outlet seat 22, and out of the drain valve 10. In this alignment, as in FIG. 2, the signal 42 generated by the sensor 40 and/or actuator 50 to the indicator 44 and/or the controller 46 will reflect a pressure downstream of the inlet seat 18 that, while less than the static pressure in the pressurized system 24, is sufficiently greater than atmospheric pressure to indicate that the drain valve 10 is in the process of draining fluid from the pressurized system 24. While manually draining fluid through the drain valve 10 is not normally a cause for concern, uncontrolled or continuous fluid flow through the drain valve 10 may indicate a misalignment of the drain valve 10, a leaking drain valve 10, or other condition requiring attention to avoid an excessive loss of fluid from the pressurized system 24. The control signal 48, if present, may thus be used to implement corrective action, possibly after a specified time interval, to stop the fluid flow through the drain valve 10, provide a warning indication, or initiate other action to prevent damage in the pressurized system 24.

In FIG. 4, the first valve member 14 is again in sealing engagement with the first outlet seat 20, and the second valve member has been repositioned to the first location in sealing engagement with the inlet seat 18. As a result, the drain valve 10 is effectively isolated from the pressurized system 24, and the pressure downstream of the inlet seat 18 should approximately equal ambient pressure. In this alignment, the signal 42 generated by the sensor 40 and/or actuator 50 to the indicator 44 and/or the controller 46 will reflect and abnormally low pressure downstream of the inlet seat 18, indicating that the drain valve 10 is not aligned for normal operation. The control signal 48, if present, may thus be used to implement corrective action to prevent damage in the pressurized system 24 due to the non-availability of the drain valve 10.

One of ordinary skill in the art will readily appreciate that the system described and illustrated in FIGS. 1-4 provides a method for operating a drain valve. The method may include moving the first element 14 in the valve body 12 to allow fluid flow through said valve body 12, moving the second element 16 in the valve body 12 to allow fluid flow through the valve body 12, and sensing the pressure in the valve body 12. In particular embodiments, the method may further include remotely moving at least one of the first or second elements 14, 16 and/or comparing the pressure in the valve body 12 to the predetermined limit. The method may also include indicating a position of at least one of the first or second elements 14, 16 based on the pressure in the valve body 12 and/or generating the control signal 48 based on the pressure in the valve body 12.

It is believed that various embodiments of the present invention will reliably and accurately indicate the alignment of the drain valve 10 and provide a visible and/or audible indication of the alignment and/or implement corrective action for an incorrect alignment of the drain valve 10. As a result, embodiments of the present invention may reduce and/or prevent the occurrence of damage or wear to the pressurized system 24 and/or the drain valve 10.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other and examples are intended to be within the scope of the claims if they include structural elements that do not differ from the literal language of the claims, or if they include equivalent structural elements with insubstantial differences from the literal languages of the claims.

What is claimed is:

1. A drain valve comprising:
a. a valve body, wherein said valve body defines an inlet seat and a first outlet seat downstream of said inlet seat;
b. a first member, wherein said first member has a first position in sealing engagement with said first outlet seat and a second position separated from said first outlet seat;
c. a second member, wherein said second member has a first location in sealing engagement with said inlet seat; and
d. a sensor downstream of said inlet seat, wherein said sensor generates a signal reflective of a pressure downstream of said inlet seat.

2. The drain valve as in claim 1, further comprising a bias member operatively connected to said first member to bias said first member to said first position in sealing engagement with said first outlet seat.

3. The drain valve as in claim 1, further comprising means for moving said first member between said first position and said second position.

4. The drain valve as in claim 1, further comprising a solenoid operatively connected to said first member for moving said first member between said first position and said second position.

5. The drain valve as in claim 1, further comprising an indicator, wherein said indicator receives said signal from said sensor.

6. The drain valve as in claim 1, further comprising a controller, wherein said controller receives said signal from said sensor.

7. The drain valve as in claim 6, wherein said controller compares said signal from said sensor to a predetermined limit.

8. The drain valve as in claim 6, wherein said controller generates a control signal in response to said signal from said sensor.

9. A drain valve comprising:
a. a valve body, wherein said valve body defines an inlet seat and first and second outlet seats downstream of said inlet seat;
b. a first member, wherein said first member has a first position in sealing engagement with said first outlet seat and a second position separated from said first outlet seat;
c. a second member, wherein said second member has a first location in sealing engagement with said inlet seat and a second location in sealing engagement with said second outlet seat; and
d. an actuator operatively connected downstream of said inlet seat, wherein said actuator compares a pressure downstream of said inlet seat to a predetermined limit.

10. The drain valve as in claim 9, further comprising a bias member operatively connected to said first member to bias said first member to said first position in sealing engagement with said first outlet seat.

11. The drain valve as in claim 9, further comprising means for moving said first member between said first position and said second position.

12. The drain valve as in claim 9, further comprising a solenoid operatively connected to said first member for moving said first member between said first position and said second position.

13. The drain valve as in claim 9, further comprising an indicator operatively connected to said actuator, wherein said indicator provides an indication of the pressure between said inlet seat and said second outlet seat.

14. The drain valve as in claim 9, wherein said actuator generates a control signal in response to the pressure between said inlet seat and said second outlet seat.

15. A method for operating a drain valve comprising:
a. moving a first element in a valve body to allow fluid flow through said valve body;
b. moving a second element in said valve body to allow fluid flow through said valve body;
c. sensing a pressure in said valve body.

16. The method as in claim 15, further comprising remotely moving at least one of said first element or said second element.

17. The method as in claim 15, further comprising moving at least one of said first element or said second element to prevent fluid flow through said valve body.

18. The method as in claim 15, further comprising comparing the pressure in said valve body to a predetermined limit.

19. The method as in claim 15, further comprising indicating a position of at least one of said first element or said second element based on the pressure in said valve body.

20. The method as in claim 15, further comprising generating a control signal based on the pressure in said valve body.
